(19) United States
(12) Patent Application Publication
(10) Pub. No.: US 2013/0101861 A1
(43) Pub. Date: Apr. 25, 2013

(54) D1486 LOW GLOSS RADIATION CURABLE COATING FOR CONCREATE FLOORS

(71) Applicants: Huimin Cao, Addison, IL (US); Wenguang Li, St. Charles, IL (US); Tai Yeon Lee, Crystal Lake, IL (US)

(72) Inventors: Huimin Cao, Addison, IL (US); Wenguang Li, St. Charles, IL (US); Tai Yeon Lee, Crystal Lake, IL (US)

(73) Assignee: DSM IP ASSETS B.V., Heerlen (NL)

(21) Appl. No.: 13/807,886

(22) PCT Filed: Jun. 30, 2011
(86) PCT No.: PCT/US11/42561

§ 371 Date: Dec. 31, 2012

Related U.S. Application Data
(60) Provisional application No. 61/369,219, filed on Jul. 30, 2010.

(30) Foreign Application Priority Data
Aug. 4, 2010 (EP) 10171938.3

(51) Int. Cl. C09D 133/14

(52) U.S. Cl. CPC C09D 133/14
USPC 428/451; 522/112; 522/78; 427/510

(57) ABSTRACT

Radiation-curable coating compositions for a surface such as a concrete floor, which include at least one multi-functional monomer or oligomer, at least one photoinitiator, at least one glossy band matting agent, and at least one matte band matting agent are described and claimed. These low gloss coating compositions allow for application of the coating composition over an area larger than a UV radiation source, while minimizing the formation of gloss bands or gloss lines that exhibit a different level of gloss in the areas where light leakage from a side light shielding of the UV radiation source results in a very weak radiation intensity, as compared to the areas subjected to high radiation intensity. These low gloss coating compositions are optionally clear topcoat compositions. In addition, a method for coating a surface with a radiation-curable coating composition that results in a cured surface with minimal differences in gloss exhibited following curing by a UV radiation source, and a surface coated with the radiation curable coating compositions of the instant claimed invention are described and claimed.

### FIELD OF THE INVENTION

The invention relates to the field of radiation-curable coatings. More particularly, this invention is related to the field of radiation-curable floor coatings for concrete floors.

### BACKGROUND OF THE INVENTION

Radiation-curable coatings have been applied to surfaces in various industries for decades. Radiation-curable coatings have also been employed, for example, on surfaces such as concrete floors, vinyl, wood, and the like. As the name implies, radiation-curable coatings are cured from a liquid state of matter to a solid state of matter by exposure to radiation, such as from UV light, visible light, and electron beams.

A subset of radiation-curable coatings is ultraviolet-curable coatings (hereinafter abbreviated “UV-curable coatings”). UV-curable coatings are cured by exposure to at least UV radiation; for instance the UV portion of the electromagnetic spectrum, which includes radiation wavelengths of about 100 nanometers (nm) to about 400 nanometers (nm). Higher wavelengths of radiation may also be included in addition to the UV radiation.

UV-curable coatings comprise components referred to as “photoinitiators” that absorb UV radiation and are thus raised to an excited state. The photoinitiators then either photolyze or degrade into cations or free radicals, which are extremely reactive species. The cations or free radicals react with the oligomers and/or monomers also present in the UV-curable coatings and polymerize to form cured coatings almost instantaneously, such as within seconds.

There are multiple benefits enjoyed when using UV-curable coatings as compared to existing coatings. One major benefit of using UV-curable coatings on floor surfaces is the phenomenally quick speed at which the coatings are cured. Such rapid curing allows for return to normal use of the floor without lengthy delays as required by alternate coatings, such as coatings containing solvents that must evaporate, or coatings that substantially completely cure over a time span of hours to days. Another benefit provided by many UV-curable coatings is their strong physical and chemical resistance. For example, certain UV-curable coatings applied to floor surfaces can withstand the weight and friction of a forklift driving on the cured, coated surface within minutes after the UV curing. A further benefit of certain UV-curable coatings is that they comprise 100% solids, and thus do not include volatile organic components in the coating formulations, which allows personnel to work in the area without having significant respiratory health concerns from inhalation of volatile organic components. An additional benefit of UV-curable coatings is that the fact that the polymerization reaction is initiated using UV radiation means that the coating formulation does not have a “pot life”, which refers to the need to use the coating within a certain period of time before it polymerizes in its own container, due to having been mixed with a reactive component. Being a one-component formulation helps eliminate waste from individual projects, as unused coating may be stored for future use.

UV curable concrete coatings are further discussed in the article, “UV Curable Concrete Coatings” by Jo Ann Arceneaux, published in the January/February/March 2009 RADTECH Report; in the article, “Field-Applied, UV-Curable Coatings for Concrete Flooring”, by Peter T. Weissman, published in the January/February/March 2009 RADTECH Report; and in the presentation, “Field Applied UV Coatings for Concrete”, by Peter T. Weissman, presented at the UV/EB East October 2009.

Patent publication no. WO 01/04217 describes wax-coated, silica-matting agents and their application in the matting of radiation curable systems.

PCT Patent Application, PCT/US2010/60647, “D1446 BT LED Curing of Radiation Curable Floor Coatings”, describes and claims radiation curable coatings for floors which can be cured by the application of light from a Light Emitting Diode (abbreviated LED).

A drawback to UV-curable coatings for large surfaces relates to the use of UV radiation sources that are smaller in at least one direction, such as width, than the surface to be cured. For example, typical UV curing instruments are portable machines having a cure width of between about 0.66-0.86 meters (26 inches and 34 inches). To cure a large floor surface, then, the machine must be passed over the floor, curing an area of just 0.66-0.86 meters (26-34 inches) wide at a time across the length of the floor, followed by curing another area, the width of the machine, directly adjacent to the prior area. The one or more lamps, bulbs, and/or light emitting diodes (LEDs) fixed to the UV curing instrument direct emitted UV radiation at the floor surface to cure the coating, such as at a power of between about 4000-20000 watts per meter (100 to 500 watts per inch). Despite advances to the design of such portable UV radiation sources, there still exists a stray light zone at the edges of the cure unit where extremely low intensity light leakage from the side light shielding of the machine is sufficient to initiate polymerization of coatings, but insufficient to drive the polymerization to high degree.

Gloss is associated with the capacity of a surface to reflect more light in some directions than in others. High gloss surfaces reflect a high proportion of light directed at them and low gloss surfaces reflect a low proportion of light directed at them. The directions associated with mirror (or specular) reflection normally have the highest reflectances. Measurements by such a test method (as described for example in ASTM D523-08) correlate with visual observations of surface shininess made at roughly the corresponding angles. Low gloss coatings that produce less image impairment are often more pleasing aesthetically. The term “low gloss” as used herein refers to a measured gloss level of less than about 80 as determined using ASTM Standard D523-08, at 60°.

Low gloss radiation-curable coating compositions have been employed in the art of radiation-curable coatings, and may provide numerous benefits. The amount of gloss selected for a coating composition is often a matter of personal preference, or even a matter of fashion. Some advantages of low gloss radiation-curable coating compositions include for example and without limitation, low glare, hiding surface defects, modifying surface texture, and providing the appearance that a surface is dry. Low gloss in a cured coating is usually achieved through the addition of at least one matting agent in a radiation-curable coating composition. Several typical matting agents employed in low gloss coatings include silica (such as amorphous silicon dioxide), diatomaceous earth, heavy metal soaps, talcum and chalk.

While low gloss with UV-curable coatings has already been successfully achieved in many applications, it remains a problem to obtain uniform low gloss level throughout the entire surface in the field applications where the surface is larger than the curing pass and multiple curing passes are applied to cure the surface. When solvent borne or water borne low gloss coatings are applied on a surface such as a floor, uniform gloss level can be easily achieved once the solvent or water flashes off from the coating. This is because the volume shrinkage causes the matting agent particles to become uniformly dispersed on the coating surface. However, for 100% solids UV curable coatings where the only volume shrinkage is from radiation cure shrinkage, the gloss level is directly related to the coating cure degree, especially the surface cure degree. For high solids (about 90% by weight or higher solids) UV-curable coatings, the final gloss of the cured coating is greatly influenced by the cure degree, especially the surface cure degree. When the high solids UV curable low gloss coatings are cured by a floor curing unit, light leakage adjacent to the side edges of the light shield of the UV radiation source often results in the formation of a gloss band or gloss line comprising a different level of gloss in the partially cured coating area of a coating composition containing matting agents, as compared to the fully cured area. The gloss band (or line) remains visible at the cured surface, even upon complete curing by the next curing pass. Each pass down the length of a floor may then be observed as a visible gloss band located at or near the edge of the cured area, which is imparted by the difference in gloss between the band and the remainder of the cured surface area. The gloss band or line comprises a width located within or near a shoulder area adjacent to the completely cured main body area.

A radiation gradient present at the front of a UV radiation source is rarely problematic, because as the UV radiation source proceeds forward, emitted full intensity radiation will quickly drive the polymerization reaction to completion. Similarly, a radiation gradient present at the back of a UV radiation source is not an issue as the coating at which such weak intensity light is directed has already been fully cured. Moreover, visible gloss bands or lines are usually not an issue for coatings comprising at least a measured gloss level of about 80 as determined using ASTM Standard D523-08, at 60°.

It would be advantageous to provide a low gloss UV-curable coating formulation that would allow for the application of the coating over an area larger than a UV radiation source, limiting the formation of a visible gloss band (or line) along or near the edge of each pass of the UV radiation source, in the shoulder areas where weak intensity light from a side edge of the UV radiation source is capable of partially curing the coating. In addition, it would be advantageous to provide a method for coating a surface, for example a concrete floor, with a low gloss UV-curable coating that provides a cured surface substantially devoid of gloss difference formed by partial UV curing from stray light from the UV radiation source.

The term “substantially devoid of gloss bands” as used herein means that the gloss of the cured coating appears continuous across a plurality of portions that were cured in separate passes of a UV radiation source, and that the measured gloss difference between all different portions of the cured surface, for instance between the shoulder area and the main body area, is less than a predetermined measured amount, as determined using ASTM Standard D523-08, measured at 60°. In certain embodiments, the predetermined measured amount is a difference of 10 or less.

### SUMMARY OF THE INVENTION

The first aspect of the instant claimed invention is a radiation-curable coating composition for a floor comprising: at least one multifunctional monomer or oligomer; at least one photoinitiator and at least two matting agents, wherein of which at least one of the matting agents, known as the glossy band matting agent, provides a glossy band at the shoulder area of each curing pass when included in a cured radiation curable coating composition as the only matting agent, and at least one of the matting agents, known as the matte band matting agent, provides a matte band at the shoulder area of each curing pass when included in a cured radiation curable coating composition as the only matting agent.

The second aspect of the instant claimed invention is a radiation-curable coating composition for a floor comprising: at least one multifunctional monomer or oligomer; at least one photoinitiator; at least one glossy band matting agent and at least one matte band matting agent,

wherein when the glossy band matting agent is included as the only matting agent in a UV-curable coating composition, applied over a surface; and a UV radiation source is passed over a first portion of the predetermined area of the surface to cure the coating composition on the first portion, the first portion comprising a main body area and a shoulder area directly adjacent to the main body area where weak intensity stray light leaked from the edge of the light shield of the UV radiation source;

and a UV radiation source is passed over a second portion of the predetermined area of the surface to cure the coating composition on the second portion, the second portion overlapping the shoulder area of the first portion,

wherein the measured 60° gloss at the shoulder area of the first portion is higher than the main body area following the passing of the UV radiation source over the second portion; and

wherein when the matte band matting agent is included as the only matting agent in a UV-curable coating composition, applied over a surface; and a UV radiation source is passed over a first portion of the predetermined area of the surface to cure the coating composition on the first portion, the first portion comprising a main body area and a shoulder area directly adjacent to the main body area where weak intensity stray light leaked from the edge of the light shield of the UV radiation source;

and a UV radiation source is passed over a second portion of the predetermined area of the surface to cure the coating composition on the second portion, the second portion overlapping the shoulder area of the first portion,

wherein the measured 60° gloss at the shoulder area of the first portion is lower than the main body area following the passing of the UV radiation source over the second portion.

The third aspect of the instant claimed invention is a method for coating a concrete floor comprising:

applying a low gloss coating composition over a predetermined area of a surface of a concrete floor, the coating composition comprising at least one multifunctional monomer or oligomer, at least one photoinitiator, at least one glossy band matting agent, and at least one matte band matting agent and;

passing a UV radiation source over a first portion of the predetermined area of the surface to cure the coating composition, the first portion comprising a main body area and a shoulder area directly adjacent to the main body area;

passing the UV radiation source over a second portion of the predetermined area of the surface to cure the coating composition, the second portion overlapping the shoulder area of the first portion,

wherein the difference in measured 60° gloss between the shoulder area of the first portion and the main body area is less than about 10 following the passing of the UV radiation source over the second portion.

The fourth aspect of the instant claimed invention is a coated concrete floor comprising:

a floor comprising a surface; and

a low gloss radiation-curable coating composition applied to the surface, the coating composition comprising at least one multifunctional monomer or oligomer, at least one photoinitiator, at least one glossy band matting agent, and at least one matte band matting agent.

The fifth aspect of the instant claimed invention is a coated concrete floor coated by the method comprising:

applying a low gloss radiation-curable coating composition over a predetermined area of a surface of a concrete floor, the coating composition comprising at least one multifunctional monomer or oligomer, at least one photoinitiator, at least one glossy band matting agent and at least one matte band matting agent;

passing a UV radiation source over a first portion of the predetermined area of the surface to cure the coating composition on the first portion, the first portion comprising a main body area and a shoulder area directly adjacent to the main body area;

passing the UV radiation source over a second portion of the predetermined area of the surface to cure the coating composition on the second portion, the second portion overlapping the shoulder area of the first portion,

wherein the difference in measured 60° gloss between the shoulder area of the first portion and the main body area is less than about 10 following the passing of the UV radiation source over the second portion.

The invention may be embodied in various exemplary and nonlimiting forms. In particular, this Summary is intended merely to illuminate various embodiments of the invention and does not pose a limitation on the scope of the invention. Other features and advantages of the invention will become apparent to those skilled in the art upon review of the following detailed description, claims and drawings.

### BRIEF DESCRIPTION OF THE FIGURES

FIG. 1 is a photograph of a prior art coating that has been cured with UV radiation, illustrating the formation of a gloss band.

FIG. 2 is a perspective view of a commercially available UV floor curing machine.

FIG. 3 is a graph of measured peak irradiance versus distance from the edge of the light shield of a UV floor curing machine.

FIG. 4 is a partial drawing of a bulb and a shield of a UV radiation source.

FIG. 5a is partial diagram of a large surface coated with a radiation-curable coating, over which one pass of a UV radiation source has been made.

FIG. 5b is a partial diagram of the surface of 5a, over which a second pass of a UV radiation source has been made.

FIG. 6 is a photograph of a coated floor according to an embodiment of the invention.

### DETAILED DESCRIPTION OF THE INVENTION

### Definitions

The term “gloss” or “gloss value” is defined as the specular gloss provided by ASTM D523-08 and measured at 60°.

The term “low gloss” is defined as a measured gloss level of less than about 80 as determined using ASTM Standard D523-08, at 60°.

The term “matting agent” is defined as an agent in a coating that results in a measurable lower gloss of a cured coating containing the matting agent than a cured coating not containing the matting agent.

The term “stray radiation” or “stray light” is defined as the radiation that escapes from the sides of the light shield of a radiation source, having an irradiance of less than about 10 mW/cm².

The term “shoulder area” is defined as comprising a first longitudinal edge located immediately adjacent the main body area of coating directly over which a UV radiation source has been passed. The shoulder area comprises partially cured coating, which has been subjected to weak intensity stray light leaked from the edge of the light shield of the UV radiation source. The shoulder area is further defined as comprising a second longitudinal edge located at the boundary of the partially cured coating and the coating that remains uncured. The shoulder area from the first curing pass is then fully cured after the second curing pass which overlaps the first curing pass.

The term “gloss band” is defined as an area of cured coating located at the shoulder area of each curing pass with a gloss value that is measurably higher or lower than the adjacent main body area of cured coating.

The term “glossy band” is defined as a band in a cured coating that exhibits a higher gloss value at the shoulder area of each curing pass than the adjacent main body area of cured coating.

The term “matte band” is defined as a band in a cured coating that exhibits a lower gloss value at the shoulder area of each curing pass than the adjacent main body area of cured coating.

The term “glossy band matting agent” is defined as a matting agent in a coating that provides a glossy band at the shoulder area of each curing pass when included in a cured radiation curable coating composition as the only matting agent.

The term “matte band matting agent” is defined as a matting agent in a coating that provides a matte band at the shoulder area of each curing pass when included in a cured radiation curable coating composition as the only matting agent.

As used herein, the term “about” means ±10% of the stated value.

### DETAILED DESCRIPTION

Aspects of the invention are directed to low gloss UV-curable coatings for surfaces, such as concrete floors, methods for coating low gloss UV-curable coatings onto a surface, and surfaces coated with cured low gloss UV-curable coatings.

As noted above, it would be advantageous to provide a low gloss UV-curable coating formulation that is capable of allowing the application of the coating over an area larger than a UV radiation source while limiting the formation of gloss bands in the shoulder area along or near the edge of each pass of the UV radiation source in the areas where weak intensity light from a side edge of the UV radiation source is capable of only partially curing the coating. In addition, it would be advantageous to provide a method for coating a surface, for example a concrete floor, with a low gloss UV-curable coating that provides a cured surface substantially devoid of gloss bands or lines formed by partial UV curing from stray light from the UV radiation source.

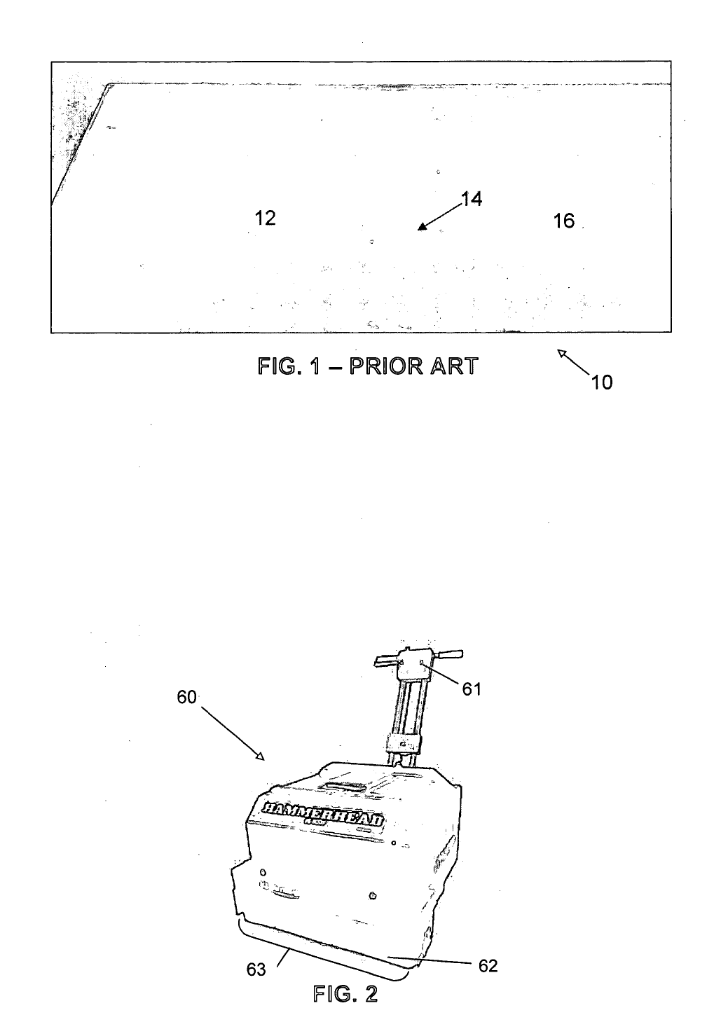

Referring to the drawings, wherein like numbers refer to like elements, FIG. 1 shows a photograph of a 0.08 mm (3 mil) thick clear prior art low gloss topcoat coating composition 10 applied on a glass plate, which illustrates the formation of a glossy band 14 when the coating is cured using radiation in two curing passes. A UV radiation source was passed over a first portion of the wet coated area to form a main body area 12 comprising dry, cured coating, a shoulder area directly adjacent the main body area comprising a partially cured coating comprising a gloss band 14. Next, a UV radiation source was passed over a second portion of the wet coated area and overlapping the shoulder area of the first portion, to form a main body area 16 comprising dry, cured coating. The photograph was taken following passing of the radiation source over the entire surface of the coating.

In addition to the term “gloss band”, the phenomenon of a section of cured coating composition that comprises a surface exhibiting more than one distinguishable level of gloss has also been referred to as a “gloss line”, due to the difference in gloss appearance of the partially cured area versus the fully cured area. The terms “gloss band” and “gloss line” are synonymous and used interchangeably herein. In general, a gloss band or gloss line comprises a section 14 located near or within the shoulder area of the coating composition and comprising a gloss level that is measurably different than the gloss level of the main body area of the coating composition, according to ASTM D523-08 and measured at 60°, as shown in FIG. 1. In certain embodiments, the measured difference in gloss level between the gloss band or gloss line and the main body area of the cured surface is at least about 4, or at least about 5, or at least about 6, or at least about 7, or at least about 8, or at least about 9, or at least about 10, or at least about 15, or at least about 20, or at least about 25. The individual gloss bands or lines provide a section 14 comprising either a higher level of measured gloss as compared to the remainder of the cured areas or a lower level of measured gloss as compared to the remainder of the cured areas. Moreover, a section 14 may instead comprise a plurality of gloss bands comprising both a higher level of measured gloss and a lower level of measured gloss as compared to the remainder of the cured areas. In this particular example, the gloss band in section 14 has higher gloss as compared to the remainder of the cured area.

Referring to FIG. 2, one exemplary commercially available radiation source machine 20 is shown. The machine 20 is a Hammerhead UV Floor Curing Equipment model 26-8000A (HID Ultraviolet, Sparta, N.J.). In operation, a UV radiation source 20 directs radiation onto a coated surface to be cured, the radiation provided from mercury vapor lamps and/or bulbs affixed to a lower section 22 of the UV radiation source machine 20. As shown in the figure, the Hammerhead instrument 20 comprises a handle 21 and is thus a machine configured to be walked behind by an operator. The Hammerhead machine 20 shown in FIG. 2 comprises a cure path of about 58.42 cm to about 66.04 cm (23 to 26 inches), consequently, a plurality of passes will be necessary to completely cure the entire coated area for most floor surface applications. The speed at which a UV radiation source instrument may be passed over a surface is restricted by the amount of light required to drive the polymerization reaction to completion. Accordingly, the speed will depend on the characteristics of specific coating formulations. UV radiation source instrument speeds typically range between about 4.57 m (15 feet) per minute and about 15.24 m (50 feet) per minute, such as between about 6.10 m (20 feet) per minute and 12.20 (40 feet) per minute, for instance about 7.62 m (25 feet) per minute. Radiation sources according to embodiments of the invention emit radiation, for example and without limitation, in the range of about 100 nm to about 700 nm or about 100 nm to about 500 nm.

An alternate radiation source is a machine comprising light emitting diodes (LEDs). LED radiation sources are disclosed in PCT Patent Application, PCT/US2010/60647, “D1446 BT LED Curing of Radiation Curable Floor Coatings” which claims priority to U.S. Provisional Patent Application No. 61/287,600 filed on Dec. 17, 2009. PCT Patent Application, PCT/US2010/60647 and U.S. Provisional Patent Application No. 61/287,600 are incorporated herein by reference in their entirety.

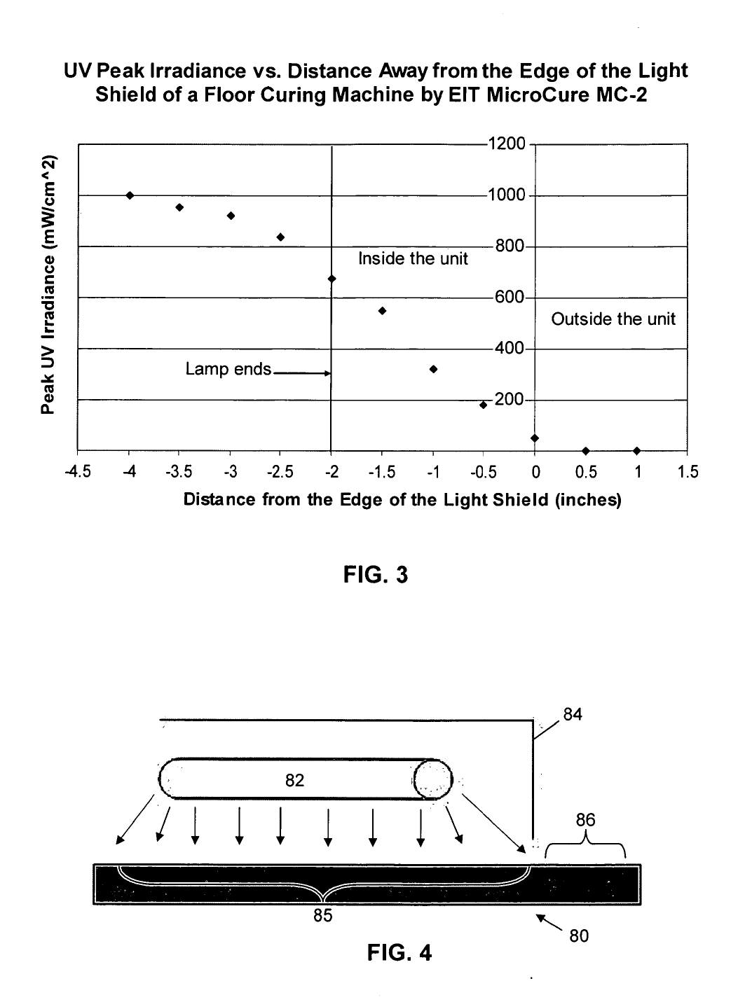

Radiation intensity can be measured at various locations with respect to a selected radiation source. For example, referring to FIG. 3, a graph is provided showing the UV-A (320-390 nm) peak irradiance for a mercury vapor bulb radiation source, as a function of the distance from the edge of the light shield. The irradiance was measured using a MicroCure MC-2 chip (EIT, Inc, Sterling, Va.). Each measurement was taken where the chip was placed on the floor, first directly in the path of the radiation emitted from the bulb. Next, the chip was placed half of an inch closer to one longitudinal side end of the bulb and the irradiance measured. For each subsequent measurement, the chip was placed an additional half of an inch closer to and then beyond the longitudinal side end of the bulb, past the light shield of the machine, and outside of the unit.

FIG. 3 illustrates the decrease in peak UV-A irradiance with respect to distance from the edge of the light shield. A typical UV-A radiation high intensity provided by such a bulb from the longitudinal center of the bulb is about 1700 mW/cm². Between the end of the bulb and the edge of the light shield, the peak irradiance dropped from 673 mW/cm² to 53 mW/cm². Interestingly, even an irradiance as low as just 53 mW/cm² can be sufficient to cure the coating to achieve similar gloss level as the main body area. It was only at area outside of the equipment shield, where the irradiance was below the minimum detectable level of about 5-10 mW/cm²; that partial curing with low double bond conversion results in visible gloss difference. As one of skill in the art will appreciate, the distance longitudinally from the end of a radiation source at which the radiation is sufficiently weak to result in only partial curing will depend on characteristics of the particular radiation source, such as the bulb, lamp or LED intensity, equipment shield configuration and location, distance of the radiation source from the coated surface, etc.

FIG. 4 provides a basic representation of the configuration of a UV radiation source lamp 42 and light shield 44 with respect to each other and a coated surface 40 to be cured. The arrows provide a depiction of the direction of the radiation provided by the lamp 42 as it is moved over the coated surface 40 during a curing pass. The main body area 45 of the coated surface 40, which is located directly below the lamp 42, receives direct high intensity light radiation, whereas the shoulder areas of the coated surface 40, which are off to the sides of the lamp 42, receive indirect light radiation. As indicated by the measurements shown in FIG. 3, a shoulder area 46, which is located on the coated surface 40 beyond the light shield 44, receives weak intensity radiation that leaks underneath and past the light shield 44. Typically, this shoulder area 46 is where a gloss band forms upon being subjected only to enough radiation to partially cure coating to low double bond conversion.

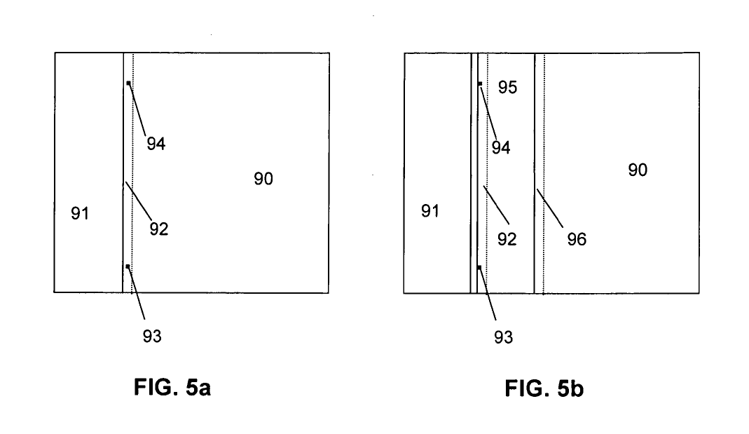

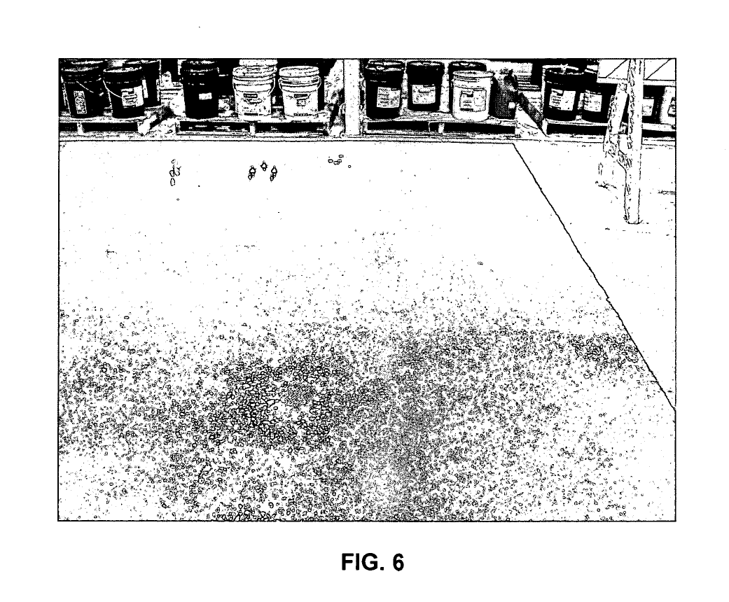

In use, a UV radiation source employed to cure a large surface coated with a radiation-curable composition will usually be passed over the surface as depicted in the representations shown in FIGS. 5a and 5b. Referring to FIG. 5a, a rectangular surface 50 is shown having a radiation-curable coating applied to the surface 50. The selected UV radiation source (not shown) is passed over the coated surface 50 starting at the lower left corner of the area shown in FIG. 5a and moving towards the upper left corner to cure the coated main body area 51 in the first pass. The weak intensity radiation that is provided adjacent to the high intensity radiation partially cures the coated shoulder area 52. As shown in FIG. 5b, the second pass of the radiation source will overlap the first curing pass and create a second main body completely cured area 53 and a second partially cured shoulder area 54. The gloss band at the shoulder area 52 of the first curing pass will remain after being fully cured by the second curing pass.

As a result, it is an advantage of coating compositions according to the present invention to prevent, minimize, or limit the formation of gloss bands or lines on the partially cured low gloss coating located in the shoulder area adjacent to a main body area that has been fully cured by a first pass of a UV radiation source.

Despite various design modifications, it is not believed that there are any available UV radiation sources that provide a radiation cutoff from high intensity light to zero light (e.g., does not provide a leakage of weak radiation at the edges of the shielding of one or more lamps, bulbs, and/or LEDs of the UV radiation source). Aspects of the present invention, however, overcome the problem of gloss band formation caused by low intensity light leakage by providing specific compositions of low gloss UV-curable coating formulations. Accordingly, the particular type or instrument model of the UV radiation source is not a significant factor in achieving UV-cured low gloss coatings substantially devoid of gloss bands according to embodiments of the invention, and any conventional UV radiation source may be employed with aspects of the current invention.

Radiation curable coatings may be made up of more than one individual coating, such as a primer coating applied directly to a surface and a topcoat applied on top of the primer. Typically, clear and pigmented primer coatings are configured to provide adhesion of the UV-curable coatings to the surface, such as to a concrete surface. Topcoats are usually formulated to provide properties such as mechanical and chemical resistance and a desired level of gloss. Due to the problem of gloss band formation, no prior art clear topcoat coating with high solids (about 90% by weight or higher solids) UV-curable compositions could be applied to large areas at a gloss level of below about 80 as measured according to ASTM D523-08, at 60°, with minimal formation of gloss bands during curing of a plurality of sections of wet coating. The present invention provides a solution to the problem of gloss band formation in low gloss UV-curable coating compositions such that coatings may be applied to large areas and cured via UV radiation, limiting the generation of visible gloss bands.

It was unexpectedly discovered that the addition of at least two different matting agents, such as polymeric wax powders, in the high solids low gloss composition minimizes the formation of gloss hands during curing. Rather, the gloss level appears continuous across a plurality of portions that were cured in separate passes of the UV radiation source. Of the at least two matting agents, at least one provides a glossy band when included in a cured radiation curable coating composition as the only matting agent and subjected to stray light with an irradiance of less than about 10 mW/cm², and at least one provides a matte band when included in a cured radiation curable coating composition as the only matting agent and subjected to stray light with an irradiance of less than about 10 mW/cm². A glossy band is provided when the gloss band in the shoulder area of a cured coating provides a gloss level greater than the level of gloss in the main area of the cured coating, as determined using ASTM D523-08, at 60°. Similarly, a matte band is provided when the gloss band in the shoulder area of a cured coating provides a gloss level less than the level of gloss in the main area of the cured coating, as determined using ASTM D523-08, at 60°. As discussed further in Example 1 below, a matting agent that provides a glossy band in the shoulder area of a cured coating is given a gloss designation of “glossy band”, whereas a matting agent that provides a matte band in the shoulder area of a cured coating is given a gloss designation of “matte band”.

The first aspect of the instant claimed invention is a radiation-curable coating composition for a floor comprising: at least one multifunctional monomer or oligomer; at least one photoinitiator and at least two matting agents, wherein of which at least one matting agents, known as the glossy band matting agent, provides a glossy band at the shoulder area of each curing pass when included in a cured radiation curable coating composition as the only matting agent, and at least one matting agents, known as the matte band matting agent, provides a matte band at the shoulder area of each curing pass when included in a cured radiation curable coating composition as the only matting agent.

Throughout this patent application the phrase, “at least two matting agents” is synonymous with phrase “two or more matting agents”.

The term “matting agent” as used herein includes any material that, when employed in a radiation-curable composition, results in a measurable gloss reduction of the cured coating as compared to the cured coating without the material. In addition to materials known in the art to act as matting agents, the term “matting agent” also includes materials typically known for other uses, such as texturizing agents, fillers, etc. Matting agents, including but not limited to polymer wax powders, have been employed to provide gloss reduction, abrasion resistance, texture, improved slip, and combinations thereof, in various surface coatings. However, it is not believed that there has been any investigation into the effects of combinations of more than one kind of matting agent, for example polymer wax powders, on gloss at extremely low radiation intensities, for instance at the stray light condition disclosed in this application. As discussed above, the amount of radiation provided by light leakage from UV radiation sources is not even above the minimum detectable level of a typical dosimeter, which is about 5-10 mW/cm². Even though the coating at the stray light area is later fully cured by the next curing pass, the effect from the partially cured surface by the stray light from the first curing pass still imparts gloss difference in this area compared with the main body area.

Without wishing to be bound by theory, it is hypothesized that at such low levels of radiation intensity, the polymerization of the monomers and/or oligomers in the composition does not provide sufficient shrinkage force to push the matting agent particles from within the coating up to the surface of the coating to thereby provide the same level of gloss exhibited at the surface of the fully cured coating that was subjected to high radiation intensity. The resulting cured coating surface of a composition comprising a single matting agent typically comprises at least one glossy band located at or near the shoulder area. Surprisingly, we found that some other matting agents give a matte band at the shoulder area.

Suitable matting agents for providing low gloss to radiation curable compositions include all polymeric, organic, or inorganic particulates, for example and without limitation, polymer powders (typically polymer wax powders), synthetic amorphous silica gel powders, micronized silica powders, precipitated silica powders, and combinations thereof. Suitable polymer powders include for example and without limitation, polyethylene wax powders, polypropylene wax powders, polyamide wax powders, cross-linked polymethyl methacrylate powders, fluorinated polyolefin wax powders, chlorinated polyolefin wax powders, polymethyl urea resin powders, urea oligomer powders, bees wax powders, carnauba wax powders, paraffin wax powders, and combinations thereof. Typical fillers that may be employed as suitable matting agents include for example and without limitation, fillers selected from the group consisting of any types of ceramic particles, clay particles, calcium carbonate particles, aluminum oxide particles, aluminum hydroxide particles, calcium sulfate particles, barium sulfate particles, hollow glass beads, solid glass beads, glass fibers, glass flakes, and combinations thereof. For example, ceramic microspheres are commercially available from 3M (St. Paul, Minn.), and Sphericel® hollow glass spheres are commercially available from Potters Industries Inc. (Valley Forge, Pa.). In certain aspects, the average particle size of the fillers comprises 300 microns or less in at least one dimension. The exact mechanism for the ability of the combinations of two or more matting agents to minimize the formation of gloss bands in the shoulder area is not well understood. It is found that the weight ratio of the two or more powders affects the extent to which the formation of gloss bands is limited in a cured coating composition, according to embodiments of the invention.

Suitable polymer powders and silica matting agents include some commercially available compounds and mixtures, for example and without limitation, Uniflat 675A polyethylene wax powder, SPP-25 polypropylene wax powder, and TexMatte 6010 cross-linked polymethyl methacrylate, which are each available from Shamrock Technologies (Newark, N.J.). In addition, MPP-25 polyethylene wax powder, Propyltex 325S polypropylene wax powder, Propylmatte 31 polypropylene wax powder, Nylotex 140 polyamide wax powder, and Nylotex 200 polyamide wax powder, which are each available from Micro Powders (Tarrytown, N.Y.). Further, Orgasol 2002 ES4 NAT polyamide wax powder, Orgasol 2001 IXC NAT polyamide wax powder, and Orgasol 3502 D NAT polyamide wax powder, which are each available from Arkema (Philadelphia, Pa.). Additionally, Pergopak polymethyl urea resin powder, which is available from Albemarle (Baton Rouge, La.), and Piafine urea oligomer powder, which is available from SKW Stickstoffwerke Piesteritz GmbH (Wittenberg, Germany). Moreover, Syloid® silica gel, which is available from W.R. Grace & Co.-Conn. (Columbia, Md.), Sylysia silica gel, which is available from Fuji Silysia Chemical, Ltd. (Research Triangle Park, N.C.), Gasil UV55C amorphous silica, which is available from PQ Corporation (Joliet, Ill.), and Acematt precipitated silica, which is available from Evonik Degussa Corporation (Parsippany, N.J.).

Examples of glossy band matting agents include SPP-25 (polypropylene wax powder), Nylotex 140 (polyamide wax powder), Nylotex 200 (polyamide wax powder) and TexMatte 6010 (cross-linked polymethyl methacrylate. Examples of matte band matting agents include Uniflat 675A (polyethylene wax powder), MPP-635 (polyethylene wax powder), and Propyltex 325S (polypropylene wax powder).

In embodiments of the invention, two or more matting agents, such as polymer wax powders, are included in the inventive radiation-curable compositions in an amount of between about 1% by weight and about 50% by weight, or between about 1% by weight and about 40% by weight, or between about 1% by weight and about 30% by weight, or between about 1% by weight and about 20% by weight, or between about 1% by weight and about 10% by weight, or between about 2% by weight and about 8% by weight, or between about 3% by weight and about 7% by weight. The amount of the two or more matting agents will also depend on the rest of the components present in the UV-curable composition. As noted above, in certain embodiments, only some ratios of the two or more matting agents result in a cured coating composition substantially devoid of gloss bands. In certain embodiments, the ratio of the matting agents is about 2:1, or about 3:1, or about 4:1, or about 5:1. For any specific two or more matting agents, there exists an ideal ratio that will give minimum gloss difference between the shoulder area and the main body.

According to embodiments of the invention, the two or more matting agents are included in radiation-curable coating compositions such that when the coating composition is cured using multiple curing passes of a radiation source, the difference in measured 60° gloss according to ASTM D523-08 between the shoulder area of a first portion and the main body of the first portion is less than about 10 following the passing of the UV radiation source over the second portion. The difference in measured 60° gloss may be less than about 9, or less than about 8, or less than about 7, or less than about 6, or less than about 5, or less than about 4, according to aspects of the invention. Such small differences in the shoulder area and the main body area result in a cured coating that is substantially devoid of visible gloss bands.

In certain embodiments, the two or more matting agents are added to any suitable topcoat coating composition, such as any commercially available topcoat coating composition, to provide a low gloss topcoat coating substantially devoid of gloss difference. In alternate embodiments, the two or more matting agents are incorporated into a coating composition during development of a portion or all of a formulation.

UV-curable compositions according to certain embodiments of the invention comprise at least one photoinitiator to initiate the polymerization reaction upon absorption of UV radiation. Photoinitiators and stabilizers are described in the reference text MODERN COATING TECHNOLOGY cited above, on pages 29-34. In general, free radical photoinitiators are well known in the art of radiation curable coatings. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of photoinitiators.

Typically, free radical photoinitiators are divided into those that form radicals by cleavage, known as “Norrish Type I” and those that form radicals by hydrogen abstraction, known as “Norrish Type II”. Certain embodiments of the invention comprise Norrish Type I photoinitiators in the UV-curable composition formulation, certain embodiments comprise Norrish Type II photoinitiators, and further embodiments comprise a combination of Norrish Type I and Norrish Type II photoinitiators. Embodiments of UV-curable coating compositions of the current invention comprise Norrish Type I photoinitiators, which generate free radicals via a fragmentation process (e.g., via cleavage). Any suitable Norrish Type I photoinitiator may be employed, for example and without limitation, a photoinitiator selected from the group consisting of acyl phosphine oxides, benzoin ethers, 2,2-diethoxyacetophenone, benzyl dimethylketal, 1-hydroxycyclohexylphenyl-ketone, 1-hydroxycyclohexyl benzophenone, 2-hydroxy-2-methyl propiophenone, 2-ethoxy-2-isobutoxyacetophenone, 2,2-dimethyl-2-hydroxyacetophenone, 2,2-dimethoxy-2-phenylacetophenone, 2,2,2-trichloro-4-t-butylacetophenone, 2,2-dimethyl-2-hydroxy-4-t-butylacetophenone, 1-phenyl-1,2-propanedione-2-O-ethoxycarbonyl ester, 1-phenyl-1,2-propanedione-2-O-benzoyl oxime, and combinations thereof.

Embodiments of UV-curable coating compositions of the current invention comprise Norrish Type II photoinitiators, which generate free radicals via a hydrogen abstraction process. Any suitable Norrish Type II photoinitiator may be employed, for example and without limitation, a photoinitiator selected from the group consisting of benzophenone, trimethylbenzophenone with methyl benzophenone, 4-methylbenzophenone, bis-(4,4′-dimethylamino)benzophenone, benzil, xanthone, thioxanthone, isopropylthioxanthone, 2-chlorothioxanone, 9,10-phenanthrenequinone, 9,10-anthraquinone, and combinations thereof. Photoinitiators are included in embodiments of the UV-curable compositions at any suitable amount, for example and without limitation, between about 0.1° A and about 5% by weight, between about 1° A and about 4% by weight, or about 3% by weight of the total composition.

UV-curable compositions according to certain embodiments of the invention comprise at least one multifunctional monomer or oligomer. As used herein, the term “multifunctional” refers to a monomer or oligomer having two or more crosslinkable double bonds. In embodiments of the invention, suitable multifunctional monomers or oligomers for the radiation-curable compositions include for example and without limitation, multifunctional monomers or oligomers typically employed in the art of radiation-curable compositions and known by persons skilled in the art. In embodiments of the invention, the one or more monomers are included in an amount of between about 5% and about 90% by weight, or about 10% and about 80%, or about 20% and about 70%, or about 30% and about 60%, or about 40% and about 50% by weight of the total UV-curable composition.

UV-curable compositions according to certain embodiments of the invention comprise at least one monomer in the high solids compositions (between about 90% and 100% by weight solids). In certain aspects, the at least one monomer is a reactive diluent monomer. Reactive diluent monomers are well known in the art of radiation curable coatings for optical fiber and many of the reactive diluent monomers that are present in radiation curable coatings for optical fiber are also used in radiation curable coatings for concrete and wood floors. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of reactive diluent monomers.

Oligomers suitable for use in the compositions of the instant claimed invention include any oligomer that is already known to be radiation curable. Suitable oligomers for the radiation-curable composition include, for example and without limitation, urethane acrylate oligomers, epoxy acrylate oligomers and polyester acrylate oligomers.

In embodiments of the invention, suitable monomers for the UV-curable compositions include for example and without limitation, monomers typically employed in the art of radiation-curable compositions and known by persons skilled in the art. In embodiments of the invention, the one or more monomers are included in an amount of between about 5% and about 90% by weight, or about 10% and about 80%, or about 20% and about 70%, or about 30% and about 60%, or about 40% and about 50% by weight of the total UV-curable composition. Due to the advantages of inventive formulations of UV-curable coating compositions, clear low gloss topcoat compositions according to certain aspects of the invention can be applied to large areas with minimal formation of gloss bands during curing. In alternate embodiments, colored or pigmented low gloss topcoat compositions can be applied to large areas with minimal formation of gloss bands during curing.

In certain embodiments, the UV-curable composition comprises a topcoat composition for application on top of a primer coat composition, for instance a primer coat composition for concrete. Such primer coat compositions are applied directly to clean surfaces to provide good adhesion of the coating to the particular surface, for example concrete. The surface may be cleaned according to methods commonly used in the art of surface coating, wherein the cleaning comprises removing debris and optionally coatings adhered to the surface. The primer coating composition may rather be applied directly to substrates such as wood, vinyl, composite materials, and the like.

In embodiments of the invention, a UV-curable coating composition is provided comprising at least one multifunctional monomer or oligomer, at least one photoinitiator, a first matting agent having a gloss designation of “glossy band” as defined herein, and a second matting agent having a gloss designation of “matte band” as defined herein. In certain embodiments of the invention, each of the first and second matting agents are provided individually in an amount of between about 1% by weight and about 20% by weight, or between about 2% by weight and about 10% by weight of the total UV-curable composition.

In an embodiment of the current invention, a method is provided for coating a concrete floor comprising applying a coating composition over a predetermined area of a surface of a concrete floor, wherein the coating composition comprises at least one multifunctional monomer or oligomer, at least one photoinitiator, a first matting agent having a gloss designation of “glossy band”, and a second matting agent having a gloss designation of “matte band”. The method further comprises passing a UV radiation source over a first portion of the predetermined area of the surface to cure the coating composition, the first portion comprising a main body area. A shoulder area is directly adjacent to the main body area. The method further comprises passing the UV radiation source over a second portion of the predetermined area of the surface to cure the coating composition, wherein the second portion overlaps the shoulder area from the first pass. The shoulder area is not visible following the passing of the UV radiation source over the second portion, for example the shoulder area is substantially devoid of gloss bands following the passing of the UV radiation source over the second portion.

In an embodiment of the current invention, a coated concrete floor is provided comprising an object, such as a floor, comprising a surface and a coating composition applied to the surface. The coating composition comprises at least one multifunctional monomer or oligomer, at least one photoinitiator, a first matting agent having a gloss designation of “glossy band”, and a second matting agent having a gloss designation of “matte band”. In an embodiment, when the coating composition is cured via a plurality of UV radiation curing passes, the main body of the curing passes comprises a measured 60° gloss according to ASTM D523-08 of less than about 80, or less than about 70, or less than about 60, or less than about 50, or less than about 40, or less than about 30, or less than about 20.

In an embodiment of the current invention, a coated concrete floor is provided coated by the method comprising applying a coating composition over a predetermined area of a surface of a concrete floor, the coating composition comprising at least one multifunctional monomer or oligomer, at least one photoinitiator, a first matting agent having a gloss designation of “glossy band”, and a second matting agent having a gloss designation of “matte band”. The method further comprises passing a UV radiation source over a first portion of the predetermined area of the surface to cure the coating composition, the first portion comprising a main body area. A shoulder area is directly adjacent to the main body area. The method further comprises passing the UV radiation source over a second portion of the predetermined area of the surface to cure the coating composition, the second portion overlaps the shoulder area from the first curing pass.

### EXAMPLES

The following examples are illustrative of embodiments of the present invention, as described above, and are not meant to limit the invention in any way.

### Example 1

A number of materials are tested for suitability as matting agents according to embodiments of the invention. The test comprises combining 5% by weight of a particular test material with 95% by weight of a clear high gloss prior known topcoat composition. The prior art topcoat composition is a sample starting point clear radiation-curable formulation provided on the Cytec Technical Data Sheet for Ebecryl™ 891. The clear topcoat composition is listed in Table 1. The materials tested are listed in Table 2 below.

TABLE 1
High Gloss Prior Art Topcoat Coating Formulation

| | | Amount |
|---|---|---|
| Product | Property | (wt %) |
| Ebecryl ® 891 | coating performance | 25% |
| Ebecryl ® 81 | surface cure | 15% |
| Ebecryl ® 140 | hardness | 20% |
| NPG(PO)2DA/ | viscosity reduction | 29.6% |
| DPGDA (50/50) | | |
| Additol ® BP | surface cure | 2% |
| Additol HDMAP | multipurpose | 3% |
| Additol TPO | through cure | 0.4% |
| Ebecryl ® P115 | surface cure | 5% |
| | Total: | 100% |

A UV-curable coating is prepared comprising a combination of one test matting agent and the clear topcoat composition (as shown in Table 1), which is then applied to a clean metal plate surface, to a thickness of 0.10 mm (4 mils). Next, the coating is cured by two passes using a HID Hammerhead UV Floor Curing Equipment model 26-8000A (as shown in FIG. 2) as the UV radiation source. Due to the small coating area, for the first pass, the test panel is placed on one side of the curing path so that the curing machine only passes one portion of the test panel; the second pass finishes curing of the whole panel. The HID Hammerhead machine provides 8000 watts and is powered at 208/240 volts, 60 hertz, 45 amps, with an automatic propulsion cure speed of about 7.62 m (25 feet) per minute.

Following curing of the complete area, the gloss of the clear topcoat at the shoulder area (e.g., curing edge) and the gloss of the clear topcoat at the main body area are each measured using ASTM 13523-08, at 60°. When the measured gloss at the shoulder area is less than the measured gloss at the main body area for a composition containing a particular test material, that test material matting agent is designated as providing a matte band when the composition is polymerized by subjection to radiation at an irradiance of less than about 10 mW/cm². In contrast, when the measured gloss at the shoulder area is greater than the measured gloss at the main body area for a composition containing a particular test material, that test material is designated as providing a glossy band when the composition is polymerized by subjection to radiation at an irradiance of less than about 10 mW/cm². When the test material provides more than one adjacent band, the measured gloss of each band is measured and assigned an individual gloss designation. The designations of each test material as providing a glossy band, a matte band, or both, are listed in Table 2 below.

Accordingly, as defined in the instant invention, a matting agent that provides a surface gloss band at or near the shoulder area of a cured coating that is measured to have a higher level of gloss than the level of gloss of the surface of the main body area has a gloss designation of “glossy band”, when the composition only contains the one type of matting agent and is polymerized by subjection to radiation at an irradiance of less than about 10 mW/cm². According to embodiments of the invention, a glossy band matting agent, when included in a cured radiation curable coating composition as the only matting agent and subjected to stray radiation with an irradiance of less than about 10 mW/cm², has a gloss band in the shoulder area of the cured coating with a gloss value at least 1 greater, or at least 5 greater, or at least 10 greater than, or at least 20 greater than the value of gloss in the main body area of the cured coating as determined using ASTM D523-08 at 60°.

A matting agent that provides a surface gloss band at or near the shoulder area of a cured coating that is measured to have a lower level of gloss than the level of gloss of the surface of the main body area has a gloss designation of “matte band”, when the composition only contains the one type of matting agent and is polymerized by subjection to radiation at an irradiance of less than about 10 mW/cm². According to embodiments of the invention, a matte band matting agent, when included in a cured radiation curable coating composition as the only matting agent and subjected to stray radiation with an irradiance of less than about 10 mW/cm², has a gloss band in the shoulder area of the cured coating with a gloss value at least 1 less than, or at least 5 less than, or at least 10 less than, or at least 20 less than the value of gloss in the main body area of the cured coating as determined using ASTM D523-08 at 60°.

Although any suitable radiation-curable composition may be employed when determining the gloss designation of a particular matting agent, the topcoat radiation-curable composition of Table 1 may conveniently be used as a standard composition into which the matting agent is added.

TABLE 2
Determination of gloss designation of matting agents

| Matting Agent Test | | Gloss |
|---|---|---|
| Material | Material Type | Designation |
| Uniflat 675A | polyethylene wax powder | matte band |
| MPP-635 | polyethylene wax powder | matte band |
| SPP-25 | polypropylene wax powder | glossy band |
| Propyltex 325S | polypropylene wax powder | matte band |
| Propylmatte 31 | polypropylene wax powder | matte band |
| Nylotex 140 | polyamide wax powder | glossy band |
| Nylotex 200 | polyamide wax powder | glossy band |
| Orgasol 2002 ES4 NAT | polyamide wax powder | matte/glossy |
| | | bands |
| Orgasol 2001 EXD NAT | polyamide wax powder | matte/glossy |
| | | bands |
| Orgasol 3502 D NAT | polyamide wax powder | matte/glossy |
| | | bands |
| Gasil UV55C | amorphous silica | glossy/matte |
| | | bands |
| TexMatte 6010 | cross-linked polymethyl | glossy band |
| | methacrylate | |

### Example 2

A radiation-curable composition comprising a combination of a glossy band matting agent that provides a glossy band at the shoulder area (i.e., having a “glossy band” designation) and a matte band matting agent that provides a matte band at the shoulder area (i.e., having a “matte band” designation), when added to the clear topcoat composition of Table 1, provides a UV-curable composition that has the gloss characteristics described in Table 3 upon curing of more than one overlapping section of a coated surface. The UV-curable coating comprises the materials provided in Table 3 below.

A UV-curable coating is prepared comprising the materials listed in Table 3, then applied as a coating to a clean metal plate surface, to a thickness of 0.10 mm (4 mils). Next, the coating is cured according to the method described in Example 1. Following curing of the first pass, and following curing of the complete area, observation of the clear topcoat at the shoulder area (e.g., curing edge from the first curing pass) shows minimal visible gloss bands.

TABLE 3

| | | Amount |
|---|---|---|
| Product | Chemical Type | (wt %) |
| Topcoat of Table | clear radiation-curable topcoat | 92% |
| 1 | composition | |
| Nylotex 200 | polyamide wax powder (glossy band) | 6% |
| Uniflat 675A | polyethylene wax powder (matte band) | 2% |
| | Total: | 100% |
| | 60° gloss at main body area: | 60 |
| | 60° gloss at shoulder area: | 62 |

As shown above in Table 3, the 60° gloss level of the main body area and the shoulder area is measured using ASTM D523-08. The 60° gloss level of the main body area is determined to be 60 and the 60° gloss level of the shoulder area is determined to be 62. Accordingly, the difference in gloss between the main body area of the cured coating and the shoulder area exposed to low levels of irradiance is only 2.

### Example 3

A radiation-curable composition comprising a combination of one glossy band matting agent that provides a glossy band at the shoulder area and one matte band matting agent that provides a matte band at the shoulder area, when added to the clear topcoat composition of Table 1, provides a UV-curable composition that has the gloss characteristics described in Table 4 upon curing of more than one overlapping section of a coated surface. The UV-curable coating comprises the materials provided in Table 4 below.

A UV-curable coating is prepared comprising the materials listed in Table 4, then applied as a coating to a clean metal plate surface, to a thickness of 0.10 mm (4 mils). Next, the coating is cured according to the method described in Example 1. Following curing of the first pass, and following curing of the complete area, observation of the clear topcoat at the shoulder area (e.g., curing edge from the first curing pass) shows minimal visible gloss bands.

TABLE 4

| | | Amount |
|---|---|---|
| Product | Chemical Type | (wt %) |
| Topcoat of Table | clear radiation-curable topcoat | 82.5% |
| 1 | composition | |
| Nylotex 140 | polyamide wax powder (glossy matting | 15% |
| | agent) | |
| Uniflat 675A | polyethylene wax powder (matte | 2.5% |
| | matting agent) | |
| | Total: | 100% |
| | 60° gloss at main body area: | 20 |
| | 60° gloss at shoulder area: | 20 |

As shown above in Table 4, the 60° gloss level of the main body area and the shoulder area is measured using ASTM D523-08. The 60° gloss level of the main body area is determined to be 20 and the 60° gloss level of the shoulder area is determined to be 20. Accordingly, the difference in gloss between the main body area of the cured coating and the shoulder area exposed to low levels of irradiance is 0.

### Example 4

Various ratios of a combination of a glossy band matting agent that provides a glossy band at the shoulder area (i.e., having a “glossy band” designation) and a matte band matting agent that provides a matte band at the shoulder area (i.e., having a “matte band” designation), are tested to determine the extent to which, when added to a clear topcoat composition, the particular combination successfully provides a UV-curable composition that has limited gloss bands upon curing of more than one overlapping section of a coated surface. The UV-curable coating comprises the materials and amounts provided in Table 5 below.

Individual UV-curable coatings are prepared comprising the materials for each of the ratios of matting agents listed in Table 5, and then each applied as a separate coating to a clean metal surface, to a thickness of 0.10 mm (4 mils). Next, each of the coatings is cured according to the method described in Example 1. Following curing of the first pass, and following curing of the complete area, observation of the clear topcoat at the shoulder area (e.g., curing edge from the first curing pass) shows that each of the compositions shows minimized visible gloss bands to a different extent, as compared to topcoat compositions containing a single matting agent. Consequently, the ratio of two matting agents may affect the extent to which a specific UV-curable composition formulation is capable of providing a cured coating with limited gloss bands. An optimal ratio of two selected matting agents may be determined through experimentation, to provide a minimum gloss difference between the shoulder area and main body area of a cured coating.

In particular, both a 1:1 ratio and a 1.5:1 ratio of the Nylotex 200 polyamide wax powder (which provides a glossy band) and the Uniflat 675A polyethylene wax powder (which provides a matte band), included in a clear topcoat results in a cured coating having a less visible gloss band as compared to topcoat compositions containing each single matting agent, in particular a matte gloss band. The difference between the measured gloss in the main body area and the shoulder area of the cured coating for the composition having a 1:1 ratio of glossy band:matte band matting agents is 11, and the difference between the measured gloss in the main body area and the shoulder area of the cured coating for the composition having a 1.5:1 ratio of glossy band:matte band matting agents is 5. Accordingly, the 1.5:1 ratio of glossy band:matte band matting agents results in a minimized gloss band as compared to the 1:1 ratio of glossy band:matte band matting agents.

Both a 2.3:1 ratio and a 4:1 ratio of the Nylotex 200 polyamide wax powder (which provides a glossy band) to the Uniflat 675A polyethylene wax powder (which provides a matte band), included in a clear topcoat results in a cured coating having a minimized gloss band measurable using ASTM D523-08, at 60°, in particular a glossy gloss band, plus the topcoat comprising a 2.3:1 ratio also results in a matte band located directly adjacent the narrow glossy band (i.e., such that the glossy band is located between the main body area and the matte band). The difference between the measured gloss in the main body area and the shoulder area of the cured coating for the composition having a 2.3:1 ratio of glossy band:matte band matting agents is 4 (at the glossy band), and 3 (at the matte band). The difference between the measured gloss in the main body area and the shoulder area of the cured coating for the composition having a 4:1 ratio of glossy band:matte band matting agents is 5. Accordingly, the 3:1 ratio of glossy band:matte band matting agents of Example 2 above results in the most minimized gloss band as compared to any of the other ratios of glossy band:matte band matting agents of 1:1, 1.5:1, 2.3:1, and 4:1 glossy band:matte band.

TABLE 5

| | 1:1 Ratio | 1.5:1 Ratio | 2.3:1 Ratio | 4:1 Ratio |
|---|---|---|---|---|
| | Glossy | Glossy | glossy | glossy |
| | band:matte | band:matte | band:matte | band:matte |
| Product | band | band | band | band |
| Topcoat of Table 1 | 90% | 90% | 90% | 90% |
| Nylotex 200 | 5% | 6% | 7% | 8% |
| Uniflat 6751 | 5% | 4% | 3% | 2% |
| Total: | 100% | 100% | 100% | 100% |
| 60° gloss at main | 61 | 62 | 63 | 62 |
| body area: | | | | |
| 60° gloss at | 50 | 57 | 67 | 67 |
| shoulder area: | | | 60 | |

### Comparative Example 5

### Not an Example of the Instant Claimed Invention

A radiation-curable composition comprising a glossy band matting agent that provides a glossy band at the shoulder area (i.e., having a “glossy band” designation), added to a clear topcoat composition, provides a UV-curable composition that has the gloss characteristics described in Table 6 upon curing of more than one overlapping section of a coated surface. The UV-curable coating comprises the materials provided in Table 6 below.

A UV-curable coating is prepared comprising the materials listed in Table 6, then applied as a coating to a clean metal plate surface, to a thickness of 0.10 mm (4 mils). Next, the coating is cured according to the method described in Example 1. Following curing of the first pass, and following curing of the complete area, observation of the clear topcoat at the shoulder area (e.g., curing edge from the first curing pass) shows a visible gloss band.

TABLE 6
Comparative Example—Not an example of the instant claimed
invention

| | | Amount |
|---|---|---|
| Product | Chemical Type | (wt %) |
| Topcoat of Table | clear radiation-curable topcoat | 90% |
| 1 | composition | |
| Nylotex 200 | polyamide wax powder (glossy band) | 10% |
| | Total: | 100% |
| | 60° gloss at main body area: | 57 |
| | 60° gloss at shoulder area: | 79 |

As shown above in Table 6, the 60° gloss level of the main body area and the shoulder area is measured using ASTM D523-08. The 60° gloss level of the main body area is determined to be 57 and the 60° gloss level of the shoulder area is determined to be 79. Accordingly, the difference in gloss between the main body area of the cured coating and the shoulder area exposed to low levels of irradiance is 22, and a visible glossy gloss band is present on the surface of the cured coating at the shoulder area.

### Comparative Example 6

### Not an Example of the Instant Claimed Invention

A radiation-curable composition comprising a matte band matting agent that provides a matte band at the shoulder area (i.e., having a “matte band” designation), added to a clear topcoat composition, provides a UV-curable composition that has the gloss characteristics described in Table 7 upon curing of more than one overlapping section of a coated surface. The UV-curable coating comprises the materials provided in Table 7 below.

A UV-curable coating is prepared comprising the materials listed in Table 7, then applied as a coating to a clean metal plate surface, to a thickness of 0.10 mm (4 mils). Next, the coating is cured according to the method described in Example 1. Following curing of the first pass, and following curing of the complete area, observation of the clear topcoat at the shoulder area (e.g., curing edge from the first curing pass) shows a visible gloss band.

TABLE 7
Comparative Example—Not an example of the instant claimed
invention

| | | Amount |
|---|---|---|
| Product | Chemical Type | (wt %) |
| Topcoat of Table | clear radiation-curable topcoat | 90% |
| 1 | composition | |
| Uniflat 675A | polyethylene wax powder (matte band) | 10% |
| | Total: | 100% |
| | 60° gloss at main body area: | 64 |
| | 60° gloss at shoulder area: | 45 |

As shown above in Table 7, the 60° gloss level of the main body area and the shoulder area is measured using ASTM D523-08. The 60° gloss level of the main body area is determined to be 64 and the 60° gloss level of the shoulder area is determined to be 45. Accordingly, the difference in gloss between the main body area of the cured coating and the shoulder area exposed to low levels of irradiance is 19, and a visible matte gloss band is present on the surface of the cured coating at the shoulder area.

### Comparative Example 7

### Not an Example of the Instant Claimed Invention

A radiation-curable composition comprising one matting agent that provides both a glossy band and an adjacent matte band at the shoulder area (i.e., having both a “glossy band” and a “matte band” designation), added to a clear topcoat composition, provides a UV-curable composition that has the gloss characteristics described in Table 8 upon curing of more than one overlapping section of a coated surface. The UV-curable coating comprises the materials provided in Table 8 below.

A UV-curable coating is prepared comprising the materials listed in Table 8, then applied as a coating to a clean metal plate surface, to a thickness of 0.10 mm (4 mils). Next, the coating is cured according to the method described in Example 1. Following curing of the first pass, and following curing of the complete area, observation of the clear topcoat at the shoulder area (e.g., curing edge from the first curing pass) shows two adjacent visible gloss bands.

TABLE 8
Comparative Example—Not an example of the instant claimed
invention

| | | Amount |
|---|---|---|
| Product | Chemical Type | (wt %) |
| UVolve topcoat | clear radiation-curable topcoat | 95% |
| | composition | |
| Gasil UV55C | amorphous silica | 5% |
| | Total: | 100% |
| | 60° gloss at main body area: | 32 |
| | 60° gloss at shoulder area: | 45 |
| | | 25 |

As shown above in Table 8, the 60° gloss level of the main body area and the shoulder area is measured using ASTM D523-08. The 60° gloss level of the main body area is determined to be 32 and the 60° gloss levels of the two adjacent gloss bands in the shoulder area are determined to be 45 and 25. Accordingly, the difference in gloss between the main body area of the cured coating and the shoulder area exposed to low levels of irradiance are 13 and 7, respectively, and both a visible glossy gloss band and a visible matte gloss band are present on the surface of the cured coating at the shoulder area.

### Comparative Example 8

### Not an Example of the Instant Claimed Invention

A radiation-curable composition comprising a matting agent that provides both a matte band and an adjacent glossy band at the shoulder area (i.e., having both a “glossy band” and a “matte band” designation), added to a clear topcoat composition, provides a UV-curable composition that has the gloss characteristics described in Table 9 upon curing of more than one overlapping section of a coated surface. The UV-curable coating comprises the materials provided in Table 9 below.

A UV-curable coating is prepared comprising the materials listed in Table 9, then applied as a coating to a clean metal plate surface, to a thickness of 0.10 mm (4 mils). Next, the coating is cured according to the method described in Example 1. Following curing of the first pass, and following curing of the complete area, observation of the clear topcoat at the shoulder area (e.g., curing edge from the first curing pass) shows two adjacent visible gloss bands.

TABLE 9
Comparative Example—Not an example of the instant claimed
invention

| | | Amount |
|---|---|---|
| Product | Chemical Type | (wt %) |
| Ebecryl 270 | Urethane acrylate | 27.2% |
| TPGDA | Tripropyleneglycol diacrylate | 63.4% |
| Benzophenon | Photoinitiator | 3.6% |
| Irgacure 651 | Photoinitiator | 1.8% |
| Syloid C906 | Amorphous silica gel surface treated | 4.0 |
| | with 10% hydrocarbon wax (from | |
| | Grace Davison) | |
| | Total: | 100% |
| | 60° gloss at main body area: | 75 |
| | 60° gloss at shoulder area: | 55 |
| | | 80 |

As shown above in Table 9, the 60° gloss level of the main body area and the shoulder area is measured using ASTM D523-08. The 60° gloss level of the main body area is determined to be 75 and the 60° gloss levels of the two adjacent gloss bands in the shoulder area are determined to be 55 and 80. Accordingly, the difference in gloss between the main body area of the cured coating and the shoulder area exposed to low levels of irradiance are 20 and 5, respectively, and both a visible matte gloss band and a slight glossy band are present on the surface of the cured coating at the shoulder area.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

1. A radiation-curable coating composition for a floor comprising;
at least one multifunctional monomer or oligomer;
at least one photoinitiator and at least two matting agents, of which
at least one matting agents, known as the glossy band matting agent, provides a glossy band at the shoulder area of each curing pass when included in a cured radiation curable coating composition as the only matting agent, and
at least one matting agents, known as the matte band matting agent, provides a matte band at the shoulder area of each curing pass when included in a cured radiation curable coating composition as the only matting agent.

2. A radiation-curable coating composition for a floor comprising: at least one multifunctional monomer or oligomer; at least one photoinitiator; at least one glossy band matting agent and at least one matte band matting agent,
wherein when the glossy band matting agent is included as the only matting agent in a UV-curable coating composition, applied over a surface; and a UV radiation source is passed over a first portion of the predetermined area of the surface to cure the coating composition on the first portion, the first portion comprising a main body area and a shoulder area directly adjacent to the main body area where weak intensity stray light leaked from the edge of the light shield of the UV radiation source; and a UV radiation source is passed over a second portion of the predetermined area of the surface to cure the coating composition on the second portion, the second portion overlapping the shoulder area of the first portion,
wherein the measured 60° gloss at the shoulder area of the first portion is higher than the main body area following the passing of the UV radiation source over the second portion; and
wherein when the matte band matting agent is included as the only matting agent in a UV-curable coating composition, applied over a surface; and a UV radiation source is passed over a first portion of the predetermined area of the surface to cure the coating composition on the first portion, the first portion comprising a main body area and a shoulder area directly adjacent to the main body area where weak intensity stray light leaked from the edge of the light shield of the UV radiation source; and a UV radiation source is passed over a second portion of the predetermined area of the surface to cure the coating composition on the second portion, the second portion overlapping the shoulder area of the first portion,
wherein the measured 60° gloss at the shoulder area of the first portion is lower than the main body area following the passing of the UV radiation source over the second portion.

3. The coating composition according to claim 1, wherein when the coating composition is applied to a surface;
when a UV radiation source is passed over a first portion of the predetermined area of the surface to cure the coating composition, the first portion comprising a main body area and a shoulder area directly adjacent to the main body area;
and when the UV radiation source is passed over a second portion of the predetermined area of the surface to cure the coating composition, the second portion overlapping the shoulder area of the first portion, the difference in measured 60° between the shoulder area of the first portion and the main body area is less than about 10 following the passing of the UV radiation source over the second portion.

4. The coating composition according to claim 3, wherein the radiation is emitted by a source selected from the group consisting of at least one UV lamp, at least one LED, and combinations thereof; and wherein the measured 60° gloss of the main body area is less than about 60.

5. The coating composition according to claim 3, wherein the difference in measured 60° gloss between the shoulder area and the main body area is less than about 8, preferably less than about 6, more preferably less than about 5, such as less than about 4.

6. The coating composition according to claim 1, wherein the glossy band matting agent is present in an amount between about 1% by weight and about 20% by weight relative to the total weight of the coating composition and the matte band matting agent is present in an amount between about 1% by weight and about 20% by weight relative to the total weight of the coating composition.

7. The coating composition of claim 1, wherein the glossy band matting agent is selected from the group consisting of polypropylene wax powder, polyamide wax powder, cross-linked polymethyl methacrylate powder, and combinations thereof; and wherein the matte band matting agent is selected from the group consisting of polyethylene wax powder, polyethylene wax, polypropylene wax powder, and combinations thereof,
preferably the glossy band matting agent comprises polyamide wax powder and the matte band matting agent comprises polyethylene wax powder, and wherein more preferably the polyamide wax powder and the polyethylene wax powder are present in a weight ratio of between about 2:1 and about 8:1 polyamide wax powder to polyethylene wax powder.

8. The coating composition according to claim 1, wherein the coating composition is a clear topcoat coating composition or a colored topcoat coating composition.

9. The coating composition according to claim 1, wherein the glossy band matting agent and the matte band matting agent are present in a weight ratio of between about 1:1 and about 10:1, or wherein the glossy band matting agent and the matte band matting agent are present in a weight ratio of between about 1:10 and about 1:1.

10. A method for coating a concrete floor comprising:
applying a low gloss coating composition according to claim 1 over a predetermined area of a surface of a concrete floor;
passing a UV radiation source over a first portion of the predetermined area of the surface to cure the coating composition, the first portion comprising a main body area and a shoulder area directly adjacent to the main body area; and
passing the UV radiation source over a second portion of the predetermined area of the surface to cure the coating composition, the second portion overlapping the shoulder area of the first portion,
wherein the difference in measured 60° gloss between the shoulder area of the first portion and the main body area is less than about 10, preferably less than about 5, following the passing of the UV radiation source over the second portion.

11. The method according to claim 10, wherein the UV radiation source provides radiation wavelengths between about 100 nm and about 700 nm, the UV radiation preferably being emitted by a source selected from the group consisting of at least one lamp, at least one bulb, at least one LED, and combinations thereof.

12. A coated concrete floor comprising:
a floor comprising a surface; and
a low gloss radiation-curable coating composition according to claim 1 applied to the surface.

13. The coated concrete floor according to claim 12, wherein when the coating composition on the surface is subjected to a plurality of curing passes of a UV radiation source, the difference in measured 60° gloss between the should area and the main body area is less than about 10, the UV radiation is emitted by a source selected from the group consisting of at least one lamp, at least one bulb, at least one LED, and combinations thereof, and wherein the UV radiation source provides radiation wavelengths between about 100 nm and about 700 nm.

14. The coated concrete floor according to claim 12, wherein the coating composition is clear or colored.

15. Use of the radiation curable composition according to claim 1 for coating a concrete floor.
